(19) United States
(12) Patent Application Publication
(10) Pub. No.: US 2016/0283075 A1
(43) Pub. Date: Sep. 29, 2016

(54) INFORMATION PROCESSING METHOD, APPARATUS, AND SYSTEM

(71) Applicant: TENCENT TECHNOLOGY (SHENZHEN) COMPANY LIMITED, Shenzhen (CN)

(72) Inventors: Ming Luo, Shenzhen (CN); Pingfeng Cheng, Shenzhen (CN)

(21) Appl. No.: 15/173,033

(22) Filed: Jun. 3, 2016

Related U.S. Application Data
(63) Continuation of application No. PCT/CN2015/071409, filed on Jan. 23, 2015.

(30) Foreign Application Priority Data
Jan. 27, 2014 (CN) 201410039166.4

(51) Int. Cl. G06F 3/0484; G06Q 30/02; G06F 3/0481; H04L 29/08; G06F 17/21

(52) U.S. Cl. CPC G06F 3/0484; H04L 67/10; G06F 17/211; G06F 3/0481; G06Q 30/0251; G06Q 30/0277

(57) ABSTRACT

The present disclosure discloses an information processing method, apparatus, and system. The method includes: collecting, by a client, operation information that is obtained according to a user operation; determining, if the collected operation information conforms to a first preset configuration, an area in which the user operation is located is a target area, and acquiring information about the target area; storing the information about the target area; reading the information about the target area when a preset reading triggering condition is met, and sending the information about the target area; receiving first reference information and a control instruction; and displaying the first reference information according to the control instruction.

### CROSS REFERENCE TO RELATED APPLICATIONS

This is a continuation application of International Patent Application No. PCT/CN2015/071409, filed on Jan. 23, 2015, which claims priority to Chinese Patent Application No. 201410039166.4 filed on Jan. 27, 2014, the disclosures of which are incorporated by reference herein in their entirety.

### FIELD OF THE TECHNOLOGY

The present disclosure relates to Internet technologies, and in particular, to an information processing method, apparatus, and system.

### BACKGROUND OF THE DISCLOSURE

At present, when a user browses page information or watches a video by using a client, a server disposed on a network side selects relevant reference information from candidate information according to feature information of the client user, such as a gender, an interest, and a region, and pushes the reference information to the client, and the client displays the reference information for reference of the user. Usually, multiple pieces of reference information are displayed at a conspicuous position on a webpage or video (for example, the middle of the webpage or video) or reference information is displayed with a large area.

However, the practice of displaying multiple pieces of reference information at a conspicuous position on a webpage or video or displaying reference information with a large area not only cause inconvenience to browse, but also occupies network resources, leading to network speed decrease. In addition, the reference information selected by the server according to the feature information of the client user does not have a large association with information required by the user; because the pushed reference information is inaccuracy, the reference information does not have a reference value for the user.

### SUMMARY

To solve the existing technical problems, embodiments of the present invention provide an information processing method, apparatus, and system.

An embodiment of the present invention provides an information processing method, where the method includes:

collecting, by a client, operation information that is obtained according to a user operation;

determining, if the collected operation information conforms to a first preset configuration, an area in which the user operation is located is a target area, and acquiring information about the target area;

storing the information about the target area;

reading the information about the target area when a preset reading triggering condition is met, and sending the information about the target area;

receiving first reference information and a control instruction; and

displaying the first reference information according to the control instruction.

An embodiment of the present invention provides an information processing method, where the method includes:

receiving, by a server, information about a target area;

generating a control instruction according to the received information about the target area, where the control instruction is used for controlling first reference information to be displayed in the target area; and

sending the first reference information and the control instruction.

An embodiment of the present invention provides an information processing method, where the method includes:

collecting, by a client, operation information that is obtained according to a user operation;

determining, if the collected operation information conforms to a first preset configuration, an area in which the user operation is located is a target area, and acquiring information about the target area;

storing the information about the target area; and

reading the information about the target area when a preset reading triggering condition is met, and sending the information about the target area to a server;

receiving, by the server, the information about the target area;

generating a control instruction according to the received information about the target area, where the control instruction is used for controlling first reference information to be displayed in the target area; and

sending the first reference information and the control instruction to the client; and

receiving, by the client, the first reference information and the control instruction; and

displaying the first reference information according to the control instruction.

An embodiment of the present invention provides a client, where the client includes:

a collecting unit, configured to collect operation information that is obtained according to a user operation;

a first determining unit, configured to: if the collected operation information conforms to a first preset configuration, determine an area in which the user operation is located is a target area, and acquire information about the target area;

a storage unit, configured to store the information about the target area;

a reading unit, configured to read the information about the target area when a preset reading triggering condition is met, and send the information about the target area;

a first receiving unit, configured to receive first reference information and a control instruction; and

a display unit, configured to display the first reference information according to the control instruction.

An embodiment of the present invention provides a server, where the server includes:

a second receiving unit, configured to receive information about a target area;

a generating unit, configured to generate a control instruction according to the received information about the target area, where the control instruction is used for controlling first reference information to be displayed in the target area; and

a sending unit, configured to send the first reference information and the control instruction.

An embodiment of the present invention provides an information processing system, where the system includes any client described above and any server described above.

As can be known from above, technical solutions of the present disclosure include: collecting, by a client, operation information that is obtained according to a user operation; determining, if the collected operation information conforms to a first preset configuration, an area in which the user operation is located is a target area, and acquiring information about the target area; storing the information about the target area; and reading the information about the target area when a preset reading triggering condition is met, and sending the information about the target area to a server; receiving, by the server, the information about the target area; generating a control instruction according to the received information about the target area, where the control instruction is used for controlling first reference information to be displayed in the target area; and sending the first reference information and the control instruction to the client; and receiving, by the client, the first reference information and the control instruction; and displaying the first reference information according to the control instruction. Therefore, in the embodiments of the present invention, the information about the target area can be provided, so that the received reference information is displayed in the target area, thereby not only facilitating browse, but also saving network resources.

### BRIEF DESCRIPTION OF THE DRAWINGS

FIG. 1 is a schematic flowchart of a first embodiment of an information processing method according to the present disclosure;

FIG. 2 is a schematic flowchart of a second embodiment of the information processing method according to the present disclosure;

FIG. 3 is a schematic flowchart of a fourth embodiment of the information processing method according to the present disclosure;

FIG. 4 is a schematic flowchart of a first embodiment of another information processing method according to the present disclosure;

FIG. 5 is a schematic flowchart of a second embodiment of the another information processing method according to the present disclosure;

FIG. 6 is a schematic flowchart of an embodiment of still another information processing method according to the present disclosure;

FIG. 7 is a schematic structural diagram of an embodiment of a client according to the present disclosure;

FIG. 8 is a schematic structural diagram of an embodiment of a server according to the present disclosure;

FIG. 9 is a schematic structural diagram of an embodiment of an information processing system according to the present disclosure; and

FIG. 10 is a schematic diagram of a webpage according to the present disclosure.

### DESCRIPTION OF EMBODIMENTS

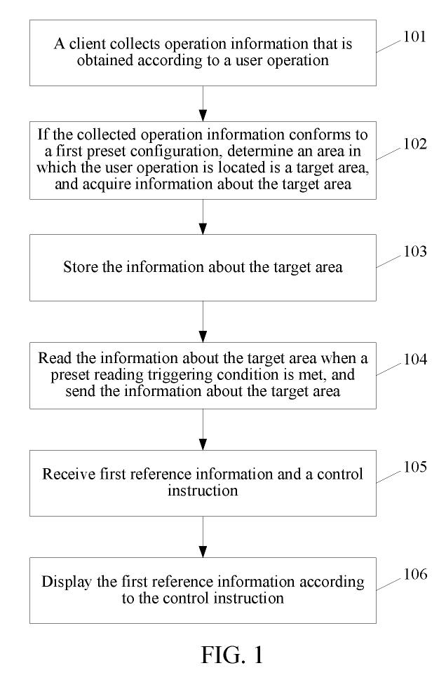

In a first embodiment of an information processing method provided by the present disclosure, as shown in FIG. 1, the method includes:

Step 101: A client collects operation information that is obtained according to a user operation.

Herein, the user operation includes an operation such as clicking a mouse, sliding a mouse, or moving a scrollbar. Specifically, an area in which the mouse is clicked and slide and a position of the scrollbar when a user browses a page may be collected by means of javascript.

Step 102: If the collected operation information conforms to a first preset configuration, determine an area in which the user operation is located is a target area, and acquire information about the target area.

Herein, the first preset configuration may include at least one of the following parameters: a frequency, the number of times, and the like. For example, if the number of times that a mouse is clicked in an area reaches a specified threshold within a preset time, this area may be determined as a target area; or if the numbers of times that the mouse is clicked and slide in an area separately reach specified thresholds within a preset time, this area may be determined as a target area. The target area is an area to which much attention has been paid recently.

The information about the target area includes position information of the target area, for example, information that can define an orientation and a range of the target area, such as boundary coordinates of the target area.

Step 103: Store the information about the target area.

Herein, the information about target area may be stored locally, that is, stored in a terminal in which the client is located, and specifically, data is stored locally for the user by means of cookie, flash, and html5. The information about target area may also be stored in a remote server, and specifically, data is recorded in a server database.

During an actual application, it is also feasible that key data is stored locally and all data is stored in a server, which can reduce the amount of locally stored data, and can acquire data from the server when local data is not complete or is lost, ensuring the security of data.

Step 104: Read the information about the target area when a preset reading triggering condition is met, and send the information about the target area.

Herein, the reading triggering condition may be startup of a browser, startup of an application, or the like. Data is preferentially acquired locally, and if the data does not exist locally or is deleted, the data is re-acquired from the server, which can improve the reading efficiency.

Step 105: Receive first reference information and a control instruction.

Herein, the first reference information may be an Internet propagation material.

Step 106: Display the first reference information according to the control instruction.

Usually, an Internet propagation material in a form such as a text, a picture, an animation, or the like is embedded on a webpage browsed by a user or a video watched by a user, where the Internet propagation material is pushed by a website.

At present, a website does not know how to place a right Internet propagation material at a right position to meet a user requirement, and therefore has no choice but to push multiple Internet propagation materials, displaying multiple Internet propagation materials at a conspicuous position on a webpage or a video or displaying Internet propagation materials with a large area. This not only wastes network resources, but also cannot effectively meet different user requirements, and even a large number of Internet propagation materials cause visual fatigue of users, cause inconvenience to browse, and decrease the speed of opening a webpage.

However, in all existing solutions of displaying an Internet propagation material to a specific user according to a directing condition, directing is usually performed according to individual information of a user (for example, a gender, an age, a city, and the like), which cannot accurately reflect true preference of the user and content in which the user is interested. As a result, a selected Internet propagation material does not have a large association with information required by the user; because the pushed Internet propagation material is inaccuracy, the Internet propagation material does not have a reference value for the user.

Actually, users have different operation habits during Internet surfing: some only view content at the beginning of a webpage while some view from the beginning to the end; some prefer to first view content on the left while some prefer to first view content on the right; some are interested in text content while some prefer to view a picture or an animation.

In this embodiment of the present invention, the Internet surfing habit of the user is recorded for targeted Internet propagation material display. That is, an area and relevant content to which the user pays much attention are recorded and analyzed, and an Internet propagation material to which the user may be interested is displayed in area to which the user often pays attention, to meet a user requirement, facilitate browse, and save network resources.

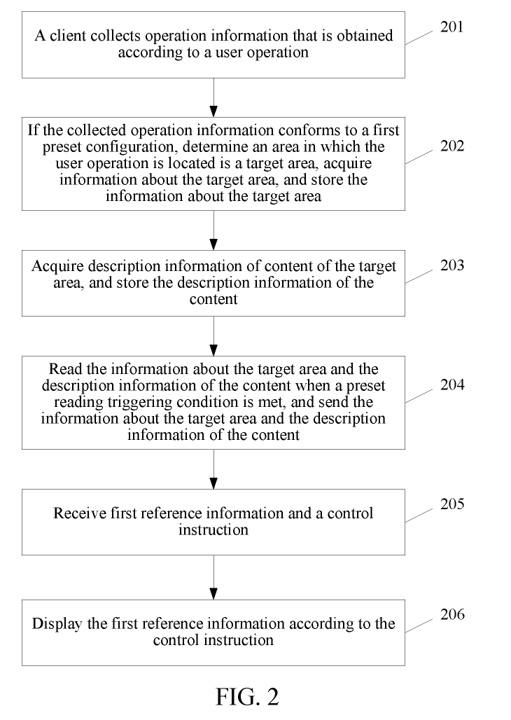

In a second embodiment of the information processing method provided by the present disclosure, as shown in FIG. 2, the method includes:

Step 201: A client collects operation information that is obtained according to a user operation.

Step 202: If the collected operation information conforms to a first preset configuration, determine an area in which the user operation is located is a target area, acquire information about the target area, and store the information about the target area.

Step 203: Acquire description information of content of the target area, and store the description information of the content.

Herein, the description information of the content includes a keyword of a browsed text, a title or description content of a browsed picture or video, or the like.

Step 204: Read the information about the target area and the description information of the content when a preset reading triggering condition is met, and send the information about the target area and the description information of the content.

Step 205: Receive first reference information and a control instruction.

Step 206: Display the first reference information according to the control instruction.

Therefore, in this embodiment of the present invention, the acquired description information of the content of the target area can be provided for reference.

In a third embodiment of the information processing method provided by the present disclosure, the method includes:

Step 1: A client collects operation information that is obtained according to a user operation.

Step 2: If the collected operation information conforms to a first preset configuration, determine an area in which the user operation is located is a target area, acquire information about the target area, and store the information about the target area.

Step 3: Acquire description information and attribute information of content of the target area, and store the description information and attribute information of the content.

Herein, the attribute information of the content includes a form of browsed content, for example, a picture, a text, a flash, a video, an animation, a color, a font, or the like.

Step 4: Read the information about the target area and the description information and attribute information of the content when a preset reading triggering condition is met, and send the information about the target area and the description information and attribute information of the content.

Step 5: Receive first reference information and a control instruction.

Step 6: Display the first reference information according to the control instruction.

Therefore, in this embodiment of the present invention, the acquired description information and attribute information of the content of the target area can be provided for reference.

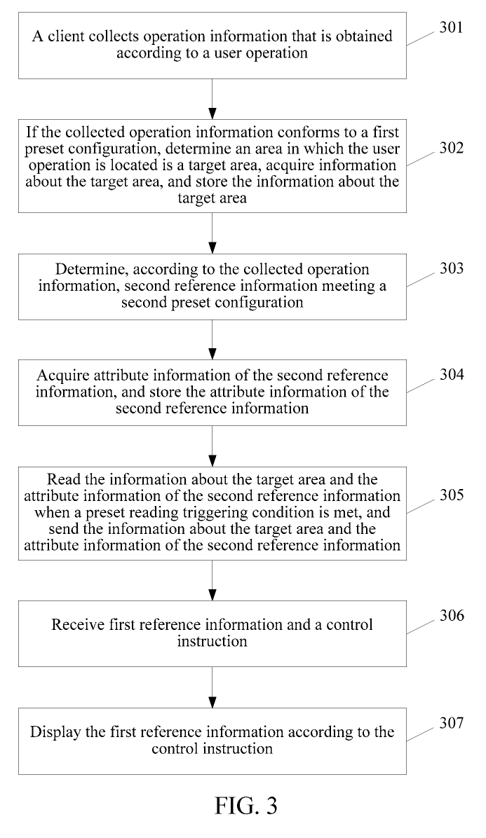

In a fourth embodiment of the information processing method provided by the present disclosure, as shown in FIG. 3, the method includes:

Step 301: A client collects operation information that is obtained according to a user operation.

Step 302: If the collected operation information conforms to a first preset configuration, determine an area in which the user operation is located is a target area, acquire information about the target area, and store the information about the target area.

Step 303: Determine, according to the collected operation information, second reference information meeting a second preset configuration.

Herein, the second reference information refers to an Internet propagation material that has been browsed or triggered by the user before, such as an advertisement.

Step 304: Acquire attribute information of the second reference information, and store the attribute information of the second reference information.

Herein, the attribute information of the second reference information includes a form (also referred to as a presentation form) of an Internet propagation material that has been browsed before, for example, a picture, a text, a flash, a video, an animation, a color, a font, or the like.

Step 305: Read the information about the target area and the attribute information of the second reference information when a preset reading triggering condition is met, and send the information about the target area and the attribute information of the second reference information.

Step 306: Receive first reference information and a control instruction.

Step 307: Display the first reference information according to the control instruction.

Therefore, in this embodiment of the present invention, the acquired attribute information of the second reference information can be provided for reference.

In a fifth embodiment of the information processing method provided by the present disclosure, the method includes:

Step 1: A client collects operation information that is obtained according to a user operation.

Step 2: If the collected operation information conforms to a first preset configuration, determine an area in which the user operation is located is a target area, acquire information about the target area, and store the information about the target area.

Step 3: Determine, according to the collected operation information, second reference information meeting a second preset configuration.

Step 4: Acquire description information and attribute information of the second reference information, and store the description information and attribute information of the second reference information.

Herein, the description information of the second reference information includes content of an Internet propagation material that has been browsed before, for example, content, an industry, or a keyword of the Internet propagation material.

Certainly, during an actual application, it is also feasible to only acquire the description information of the second reference information and store the description information of the second reference information. In this way, the information about the target area and the description information of the second reference information are read when a preset reading triggering condition is met, and the information about the target area and the description information of the second reference information are sent.

Step 5: Read the information about the target area and the description information and attribute information of the second reference information when a preset reading triggering condition is met, and send the information about the target area and the description information and attribute information of the second reference information.

Step 6: Receive first reference information and a control instruction.

Step 7: Display the first reference information according to the control instruction.

Therefore, in this embodiment of the present invention, the acquired attribute information and attribute information of the second reference information can be provided for reference.

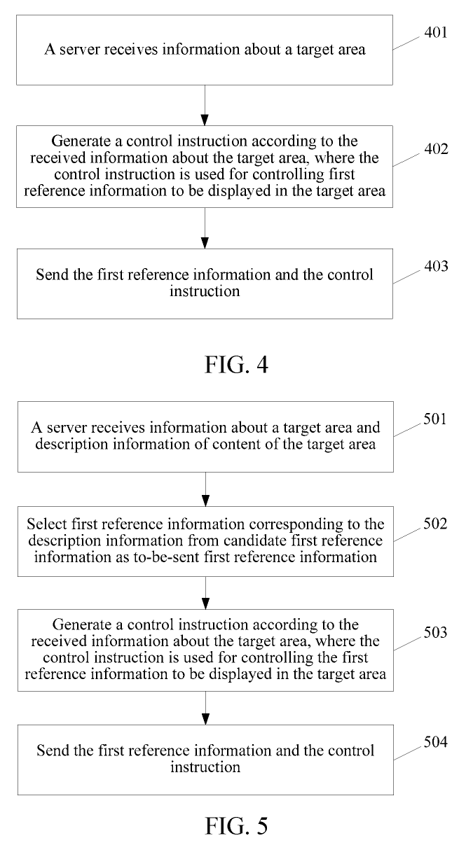

In a first embodiment of another information processing method provided by the present disclosure, as shown in FIG. 4, the method includes:

Step 401: A server receives information about a target area.

Step 402: Generate a control instruction according to the received information about the target area, where the control instruction is used for controlling first reference information to be displayed in the target area.

Step 403: Send the first reference information and the control instruction.

Therefore, in this embodiment of the present invention, the first reference information and the control instruction can be sent, so that the first reference information is displayed in the target area, thereby not only facilitating browse, but also saving network resources.

In a second embodiment of the another information processing method provided by the present disclosure, as shown in FIG. 5, the method includes:

Step 501: A server receives information about a target area and description information of content of the target area.

Step 502: Select first reference information corresponding to the description information from candidate first reference information as to-be-sent first reference information.

Step 503: Generate a control instruction according to the received information about the target area, where the control instruction is used for controlling the first reference information to be displayed in the target area.

Step 504: Send the first reference information and the control instruction.

Therefore, in this embodiment of the present invention, the first reference information can be selected according to the description information of the content of the target area, so that content of the first reference information meets a user requirement.

In a third embodiment of the another information processing method provided by the present disclosure, the method includes:

Step 1: A server receives information about a target area and description information and attribute information of content of the target area.

Step 2: Select first reference information corresponding to the description information and attribute information from candidate first reference information as to-be-sent first reference information.

Step 3: Generate a control instruction according to the received information about the target area, where the control instruction is used for controlling the first reference information to be displayed in the target area.

Step 4: Send the first reference information and the control instruction.

Therefore, in this embodiment of the present invention, the first reference information can be selected according to the description information and attribute information of the content of the target area, so that content of the first reference information better meets a user requirement.

In a fourth embodiment of the another information processing method provided by the present disclosure, the method includes:

Step 1: A server receives information about a target area and attribute information of second reference information.

Step 2: Generate a control instruction according to the received information about the target area and the attribute information of the second reference information, where the control instruction is used for controlling first reference information to be displayed in the target area in a form corresponding to the attribute information of the second reference information.

Step 3: Send the first reference information and the control instruction.

Therefore, in this embodiment of the present invention, a form of the first reference information can be determined according to the attribute information of the second reference information, so that the display form of the first reference information meets a user requirement.

In a fifth embodiment of the another information processing method provided by the present disclosure, the method includes:

Step 1: A server receives information about a target area and description information and attribute information of second reference information.

Step 2: Select first reference information corresponding to the description information from candidate first reference information as to-be-sent first reference information.

Step 3: Generate a control instruction according to the received information about the target area and the attribute information of the second reference information, where the control instruction is used for controlling the first reference information to be displayed in the target area in a form corresponding to the attribute information of the second reference information.

Step 4: Send the first reference information and the control instruction.

Therefore, in this embodiment of the present invention, the first reference information can be selected according to the description information of the second reference information, and a form of the first reference information can be determined according to the attribute information of the second reference information, so that content and the form of the first reference information further meet a user requirement.

Certainly, during an actual application, it is also feasible to only receive the information about the target area and the description information of the second reference information. First reference information corresponding to the description information is selected from candidate first reference information as to-be-sent first reference information. A control instruction is generated according to the received information about the target area, where the control instruction is used for controlling the first reference information to be displayed in the determined target area.

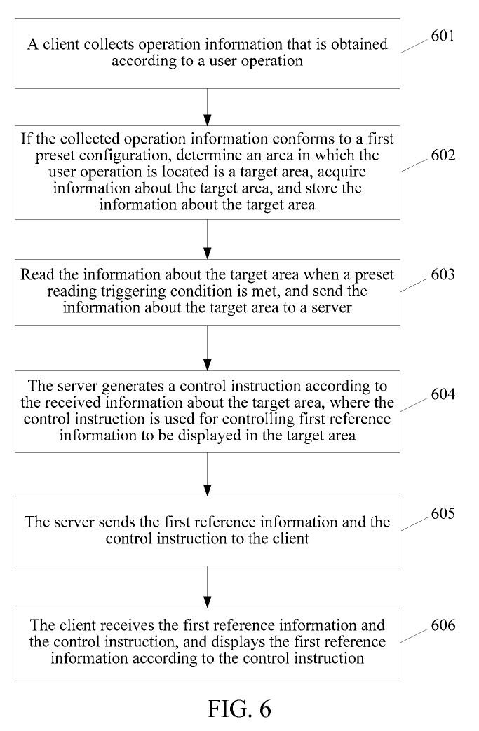

In an embodiment of still another information processing method provided by the present disclosure, as shown in FIG. 6, the method includes:

Step 601: A client collects operation information that is obtained according to a user operation.

Step 602: If the collected operation information conforms to a first preset configuration, determine an area in which the user operation is located is a target area, acquire information about the target area, and store the information about the target area.

Step 603: Read the information about the target area when a preset reading triggering condition is met, and send the information about the target area to a server.

Step 604: The server generates a control instruction according to the received information about the target area, where the control instruction is used for controlling first reference information to be displayed in the target area.

Step 605: The server sends the first reference information and the control instruction to the client.

Step 606: The client receives the first reference information and the control instruction, and displays the first reference information according to the control instruction.

Therefore, in this embodiment of the present invention, the information about the target area can be determined, so that the received reference information is displayed in the target area, thereby not only facilitating browse, but also saving network resources.

During an actual application, the server may also perform the operations of collecting operation information that is obtained according to a user operation; determining, if the collected operation information conforms to a first preset configuration, an area in which the user operation is located is a target area, acquiring information about the target area, and storing the information about the target area; reading the information about the target area; and generating a control instruction according to the received information about the target area.

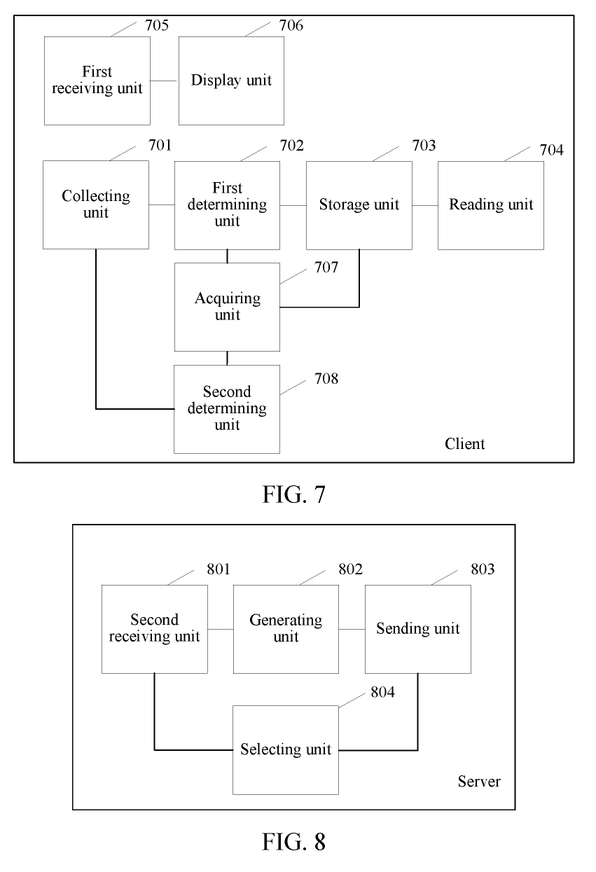

In an embodiment of a client provided by the present disclosure, as shown in FIG. 7, the client includes:

a collecting unit 701, configured to collect operation information that is obtained according to a user operation;

a first determining unit 702, configured to: if the collected operation information conforms to a first preset configuration, determine an area in which the user operation is located is a target area, and acquire information about the target area;

a storage unit 703, configured to store the information about the target area;

a reading unit 704, configured to read the information about the target area when a preset reading triggering condition is met, and send the information about the target area;

a first receiving unit 705, configured to receive first reference information and a control instruction; and

a display unit 706, configured to display the first reference information according to the control instruction.

Therefore, in this embodiment of the present invention, the information about the target area can be provided, so that the received reference information is displayed in the target area, thereby not only facilitating browse, but also saving network resources.

In an embodiment, the client further includes:

an acquiring unit 707, configured to acquire description information of content of the target area; and

correspondingly, the storage unit 703 is further configured to store the description information of the content; and

the reading unit 704 is further configured to read the description information of the content when a preset reading triggering condition is met, and send the description information of the content.

In an embodiment, the client further includes: an acquiring unit 707, configured to acquire description information and attribute information of content of the target area; and

correspondingly, the storage unit 703 is further configured to store the description information and attribute information of the content; and

the reading unit 704 is further configured to read the description information and attribute information of the content when a preset reading triggering condition is met, and send the description information and attribute information of the content.

In an embodiment, the client further includes:

a second determining unit 708, configured to determine, according to the collected operation information, second reference information meeting a second preset configuration; and

an acquiring unit 707, configured to acquire attribute information of the second reference information; and

correspondingly, the storage unit 703 is further configured to store the description information of the second reference information; and

the reading unit 704 is further configured to read the description information of the second reference information when a preset reading triggering condition is met, and send the description information of the second reference information.

In an embodiment, the client further includes:

a second determining unit 708, configured to determine, according to the collected operation information, second reference information meeting a second preset configuration; and

an acquiring unit 707, configured to acquire description information and attribute information of the second reference information; and

correspondingly, the storage unit 703 is further configured to store the description information and attribute information of the second reference information; and

the reading unit 704 is further configured to read the description information and attribute information of the second reference information when a preset reading triggering condition is met, and send the description information and attribute information of the second reference information.

In an embodiment, the acquiring unit 707 may only acquire the description information of the second reference information and does not acquire the attribute information. In this way, the storage unit 703 stores the description information. The reading unit 704 reads the information about the target area and the description information of the second reference information when a preset reading triggering condition is met, and sends the information about the target area and the description information of the second reference information.

In an embodiment of a server provided by the present disclosure, as shown in FIG. 8, the server includes:

a second receiving unit 801, configured to receive information about a target area;

a generating unit 802, configured to generate a control instruction according to the received information about the target area, where the control instruction is used for controlling first reference information to be displayed in the target area; and

a sending unit 803, configured to send the first reference information and the control instruction.

In an embodiment, the second receiving unit 801 is further configured to receive description information of content of the target area; and

correspondingly, the server further includes:

a selecting unit 804, configured to select first reference information corresponding to the description information from candidate first reference information as to-be-sent first reference information.

In an embodiment, the second receiving unit 801 is further configured to receive description information and attribute information of content of the target area; and

correspondingly, the server further includes:

a selecting unit 804, configured to select first reference information corresponding to the description information and attribute information from candidate first reference information as to-be-sent first reference information.

In an embodiment, the second receiving unit 801 is further configured to receive attribute information of second reference information; and

correspondingly, the generating unit 802 is configured to generate a control instruction according to the received information about the target area and the attribute information of the second reference information, where the control instruction is used for controlling the first reference information to be displayed in the target area in a form corresponding to the attribute information of the second reference information.

In an embodiment, the second receiving unit 801 is further configured to receive description information and attribute information of second reference information; and

correspondingly, the generating unit 802 is configured to generate a control instruction according to the received information about the target area and the attribute information of the second reference information, where the control instruction is used for controlling the first reference information to be displayed in the target area in a form corresponding to the attribute information of the second reference information; and

the server further includes:

a selecting unit 804, configured to select first reference information corresponding to the description information from candidate first reference information as to-be-sent first reference information.

In an embodiment, the second receiving unit 801 may only receive the description information of the second reference information and does not receive the attribute information. The selecting unit 804 is configured to select first reference information corresponding to the description information from candidate first reference information as to-be-sent first reference information.

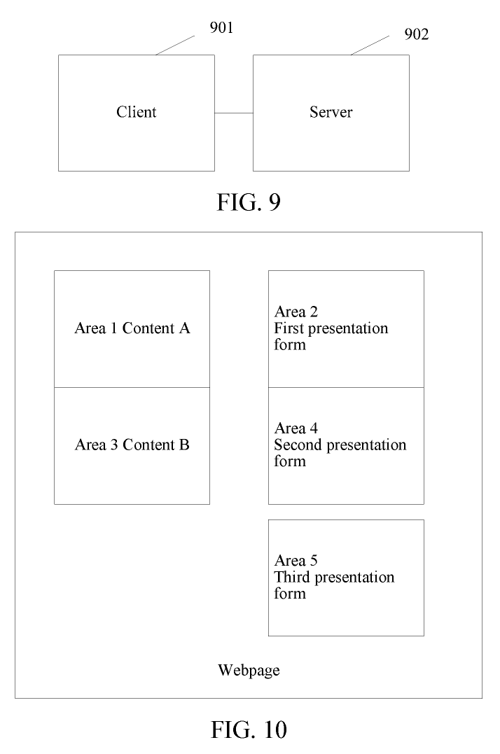

In an embodiment of an information processing system provided by the present disclosure, as shown in FIG. 9, the system includes: a client 901 and a server 902, where

the client 901 is configured to collect operation information that is obtained according to a user operation; if the collected operation information conforms to a first preset configuration, determine an area in which the user operation is located is a target area, and acquire information about the target area; store the information about the target area; read the information about the target area when a preset reading triggering condition is met, and send the information about the target area to the server; receive first reference information and a control instruction that are sent from the server; and display the first reference information according to the control instruction; and

the server 902 is configured to receive the information, sent from the client, about the target area; generate a control instruction according to the received information about the target area, where the control instruction is used for controlling the first reference information to be displayed in the target area; and send the first reference information and the control instruction to the client.

The following introduces a specific implementation manner of the present disclosure with reference to FIG. 10.

In the present disclosure, a hotspot area, presentation content, and a presentation form to which a user pays attention are analyzed by using a user behavior, and an Internet propagation material in which the user is interested is displayed in a form favored by the user, including a display area, a form of the Internet propagation material, a color of the material, and the like.

If a user A often browses content in an area 2, and pays little attention to areas 4 and 5, for the user A, an Internet propagation material is displayed in the area 2. If the user A has browsed content B in an area 3 recently, an Internet propagation material relevant to the content B is displayed at a position of the area 2. If the user A often clicks an Internet propagation material in a first presentation form in the area 2, the Internet propagation material relevant to the content B is displayed in the area 2 in the first presentation form.

If a user B pays much attention to the area 4, for the user B, an Internet propagation material is displayed in the area 4. If the user B has browsed content A in an area 1 recently, an Internet propagation material relevant to the content A is displayed in the area 4. If the user B often clicks an Internet propagation material in a third presentation form, the Internet propagation material relevant to the content A is displayed in the area 4 in the third presentation form. If the user B often clicks an Internet propagation material relevant to content B and in a second presentation form, an Internet propagation material relevant to the content A and/or the content B is displayed in the area 4 in the second presentation form.

During an actual application, content often clicked by using a mouse and an area in which the mouse is often slide when a user browses a page, an area browsed by the user on a webpage, a clicked Internet propagation material, and other operation behaviors are collected, to obtain by analysis an area, content, and a presentation form to which the user pays much attention, and an Internet propagation material in which the user is interested is displayed, in a presentation form favored by the user, in a place to which the user pays much attention.

In conclusion, in the present disclosure, the Internet surfing habit of the user is recorded for targeted Internet propagation material display. That is, an area and relevant content to which the user pays much attention are recorded and analyzed, and an Internet propagation material to which the user may be interested is displayed in area to which the user often pays attention, to meet a user requirement, facilitate browse, and save network resources.

A person skilled in the art should understand that the embodiments of the present invention may be provided as a method, a system, or a computer program product. Therefore, the present disclosure may use a form of a hardware embodiment, a software embodiment, or an embodiment combining software and hardware. In addition, the present disclosure may use a form of a computer program product implemented on one or more computer-usable storage media (including but not limited to a disk memory, an optical memory, and the like) including computer-usable program code.

The present disclosure is described with reference to flowcharts and/or block diagrams of the method, device (system), and the computer program product in the embodiments of the present invention. It should be understood that computer program instructions can implement each process and/or block in the flowcharts and/or block diagrams and a combination of processes and/or blocks in the flowcharts and/or block diagrams. These computer program instructions may be provided to a general-purpose computer, a dedicated computer, an embedded processor, or a processor of another programmable data processing device to generate a machine, so that an apparatus configured to implement functions specified in one or more processes in the flowcharts and/or one or more blocks in the block diagrams is generated by using instructions executed by the general-purpose computer or the processor of another programmable data processing device.

These computer program instructions may also be stored in a computer readable memory that can instruct a computer or another programmable data processing device to work in a specific manner, so that the instructions stored in the computer readable memory generate an artifact including an instruction apparatus, where the instruction apparatus implements functions specified in one or more processes in the flowcharts and/or one or more blocks in the block diagrams.

These computer program instructions may also be loaded into a computer or another programmable data processing device, so that a series of operation steps are performed on the computer or another programmable data processing device to generate computer-implemented processing, and instructions executed on the computer or another programmable data processing device provide steps for implementing functions specified in one or more processes in the flowcharts and/or one or more blocks in the block diagrams.

The foregoing descriptions are merely preferred embodiments of the present invention, but not intended to limit the protection scope of the present disclosure.

What is claimed is:

1. An information processing method, comprising:
collecting, by a client, operation information that is obtained according to a user operation;
determining, if the collected operation information conforms to a first preset configuration, an area in which the user operation is located is a target area, and acquiring information about the target area;
storing the information about the target area;
reading the information about the target area when a preset reading triggering condition is met, and sending the information about the target area;
receiving first reference information and a control instruction; and
displaying the first reference information according to the control instruction.

2. The method according to claim 1, wherein the method further comprises:
acquiring description information of content of the target area;
storing the description information of the content; and
reading the description information of the content when a preset reading triggering condition is met, and sending the description information of the content.

3. The method according to claim 1, wherein the method further comprises:
acquiring description information and attribute information of content of the target area;
storing the description information and attribute information of the content; and
reading the description information and attribute information of the content when a preset reading triggering condition is met, and sending the description information and attribute information of the content.

4. The method according to claim 1, wherein the method further comprises:
determining, according to the collected operation information, second reference information meeting a second preset configuration;
acquiring attribute information of the second reference information;
storing the attribute information of the second reference information; and
reading the attribute information of the second reference information when a preset reading triggering condition is met, and sending the attribute information of the second reference information.

5. The method according to claim 1, wherein the method further comprises:
determining, according to the collected operation information, second reference information meeting a second preset configuration;
acquiring description information of the second reference information;
storing the description information of the second reference information; and
reading the description information of the second reference information when a preset reading triggering condition is met, and sending the description information of the second reference information.

6. An information processing method, comprising:
receiving, by a server, information about a target area;
generating a control instruction according to the received information about the target area, wherein the control instruction is used for controlling first reference information to be displayed in the target area; and
sending the first reference information and the control instruction.

7. The method according to claim 6, wherein the method further comprises:
receiving, by the server, description information of content of the target area; and
selecting first reference information corresponding to the description information from candidate first reference information as to-be-sent first reference information.

8. The method according to claim 6, wherein the method further comprises:
receiving, by the server, description information and attribute information of content of the target area; and
selecting first reference information corresponding to the description information and attribute information from candidate first reference information as to-be-sent first reference information.

9. The method according to claim 6, wherein the method further comprises:
receiving, by the server, attribute information of second reference information; and
correspondingly, the generating a control instruction according to the received information about the target area is:
generating a control instruction according to the received information about the target area and the attribute information of the second reference information, wherein the control instruction is used for controlling the first reference information to be displayed in the target area in a form corresponding to the attribute information of the second reference information.

10. The method according to claim 6, wherein the method further comprises:
receiving, by the server, description information of second reference information; and
selecting first reference information corresponding to the description information from candidate first reference information as to-be-sent first reference information.

11. A client, comprising:
a collecting unit, configured to collect operation information that is obtained according to a user operation;
a first determining unit, configured to: if the collected operation information conforms to a first preset configuration, determine an area in which the user operation is located is a target area, and acquire information about the target area;
a storage unit, configured to store the information about the target area;
a reading unit, configured to read the information about the target area when a preset reading triggering condition is met, and send the information about the target area;
a first receiving unit, configured to receive first reference information and a control instruction; and
a display unit, configured to display the first reference information according to the control instruction.

12. The client according to claim 11, wherein the client further comprises:
an acquiring unit, configured to acquire description information of content of the target area; and
correspondingly, the storage unit is further configured to store the description information of the content; and
the reading unit is further configured to read the description information of the content when a preset reading triggering condition is met, and send the description information of the content.

13. The client according to claim 11, wherein the client further comprises: an acquiring unit, configured to acquire description information and attribute information of content of the target area; and
correspondingly, the storage unit is further configured to store the description information and attribute information of the content; and
the reading unit is further configured to read the description information and attribute information of the content when a preset reading triggering condition is met, and send the description information and attribute information of the content.

14. The client according to claim 11, wherein the client further comprises:
a second determining unit, configured to determine, according to the collected operation information, second reference information meeting a second preset configuration; and
an acquiring unit, configured to acquire attribute information of the second reference information; and
correspondingly, the storage unit is further configured to store the attribute information of the second reference information; and
the reading unit is further configured to read the attribute information of the second reference information when a preset reading triggering condition is met, and send the attribute information of the second reference information.

15. The client according to claim 11, wherein the client further comprises:
a second determining unit, configured to determine, according to the collected operation information, second reference information meeting a second preset configuration; and
an acquiring unit, configured to acquire description information of the second reference information; and
correspondingly, the storage unit is further configured to store the description information of the second reference information; and
the reading unit is further configured to read the description information of the second reference information when a preset reading triggering condition is met, and send the description information of the second reference information.

16. A server, comprising:
a second receiving unit, configured to receive information about a target area;
a generating unit, configured to generate a control instruction according to the received information about the target area, wherein the control instruction is used for controlling first reference information to be displayed in the target area; and
a sending unit, configured to send the first reference information and the control instruction.

17. The server according to claim 16, wherein the second receiving unit is further configured to receive description information of content of the target area; and
correspondingly, the server further comprises:
a selecting unit, configured to select first reference information corresponding to the description information from candidate first reference information as to-be-sent first reference information.

18. The server according to claim 16, wherein the second receiving unit is further configured to receive description information and attribute information of content of the target area; and
correspondingly, the server further comprises:
a selecting unit, configured to select first reference information corresponding to the description information and attribute information from candidate first reference information as to-be-sent first reference information.

19. The server according to claim 16, wherein the second receiving unit is further configured to receive attribute information of second reference information; and
correspondingly, the generating unit is configured to generate a control instruction according to the received information about the target area and the attribute information of the second reference information, wherein the control instruction is used for controlling the first reference information to be displayed in the target area in a form corresponding to the attribute information of the second reference information.

20. The server according to claim 16, wherein the second receiving unit is further configured to receive description information of second reference information; and
correspondingly, the server further comprises:
a selecting unit, configured to select first reference information corresponding to the description information from candidate first reference information as to-be-sent first reference information.
